(19) United States
(12) Patent Application Publication
(10) Pub. No.: US 2003/0044262 A1
(43) Pub. Date: Mar. 6, 2003

(54) Load handling system

(75) Inventor: Yoshitaka Inui, Gamo-gun (JP)

Correspondence Address: D. Peter Hochberg Co., L.P.A., The Baker Building, 6th Floor, 1940 East 6th Street, Cleveland, OH, 44114-2294, US

(73) Assignee: Daifuku Co., Ltd.

(21) Appl. No.: 10/228,761

(22) Filed: Aug. 27, 2002

(30) Foreign Application Priority Data
Aug. 31, 2001 (JP) 2001-262586

(51) Int. Cl. B65G 1/00

(52) U.S. Cl. 414/331.01

(57) ABSTRACT

In a conventional load handling system which has a load storage device and a load handling device and moves a load between these devices, when the load is not resistant to dust and the like, the entire system including the load storage device needs be provided inside a clean room, resulting in high installation costs and high operating costs of the system. Thus, the system cannot be readily adopted. In contrast, a load take in/out sections each for the load storage device and the load handling device are provided to face the clean room defined by partition walls, and a load is transferred between these devices inside the clean room. Thus, although the load storage device and the load handling device can be placed in a non-clean room (an atmospheric air chamber, etc.), a load can be moved between the load storage device and the load handling device in a sufficiently clean atmosphere by using the clean room. The system does not need be entirely formed as a clean room, so that the installation costs and operating costs of the system can be reduced. Hence, the system can be readily adopted.

### FIELD OF THE INVENTION

The present invention relates to a load handling system used for, for example, transferring loads between a load storage device and a load handling device.

### BACKGROUND OF THE INVENTION

Conventionally, an automated warehouse disclosed in Japanese Patent Unexamined Publication No. 10-279023 has been provided as this kind of system. To be specific, in such a conventional configuration, a pair of racks having a number of transverse storage positions are arranged in spaced apart parallel relationship. And then, a transfer device is provided between the pair of racks with the space therebetween serving as a traveling path, and a rotary rack is provided on the respective outer ends of the traveling path.

The transfer device comprises a travel cart which travels along a lifting and lowering rail placed on one of the racks, a turn table provided on the travel cart, an arm and a hand provided on the turn table, and so on. A plurality of transfer stations are provided on the rack, and a traveling rail for an overhead traveling vehicle is provided above the transfer stations.

According to such a conventional configuration, with the combination of lifting/lowering of the lifting and lowering rail, traveling of the travel cart, rotation of the turn table, and an action of the hand, a load is delivered between the transfer stations, the storage positions of both of the racks, and the rack plates of the rotary racks, respectively. At this moment, the rotary racks are rotated properly. Further, a load can be delivered between the transfer station and the overhead travel cart which is stopped above the transfer station by traveling via the lifting and lowering rail.

However, according to the above-described conventional configuration, when a load is not resistant to dust and so on, the entire system including the automated warehouse needs to be provided in a clean room. Therefore, such a system has not been readily adopted because of high installation cost and high operating cost of the system.

Moreover, in order to increase an amount of storage, the racks need be formed with an increased height or length. Here, the formation of higher racks is restricted by the scale of a building, and such racks cannot be readily adopted when a clean space such as a clean room needs be minimized in size. Further, when longer racks are formed, an occupied space is enlarged accordingly, therefore longer racks have not been readily adopted for such a place as a clean room.

### DISCLOSURE OF THE INVENTION

Thus, the present invention has an object to provide a load handling system which transfers loads between a load storage device and a load handling device by using a clean room at lower installation costs and lower operating costs.

Further, preferable Embodiments 3 and 4 of the present invention have as an object to provide a load handling system, in which a load storage device can be entirely compact, a storing amount is increased, and a load can be readily taken in and out to and from the outside without largely reducing a storing amount.

In order to attain the above objects, the load handling system of the present invention has a load storage device and a load handling device, wherein load take in/out sections for the load storage device and the load handling device are provided to face a clean room defined by partition walls, so that a load can be transferred between the load storage device and the load handling device in the clean room.

According to the present invention, although the load storage device and the load handling device can be placed in a non-clean room (an atmospheric air chamber, etc.), a load can be moved between the load storage device and the load handling device by using the clean room in a sufficiently clean atmosphere. Hence, it is not necessary to entirely form a clean room, and the installation costs and operating costs are reduced, so that the system can be readily adopted.

Preferable Embodiment 1 of the load handling system of the present invention is characterized in that the load storage device and the load handling device have a load take in/out section formed on the outer plates of the devices, and the outer plates are also used as partition walls.

According to Embodiment 1, it is possible to reduce an amount of used materials of the partition walls with lower cost and to achieve mutual reinforcement.

Preferable Embodiment 2 of the load handling system of the present invention is characterized by comprising load transfer means for transferring a load between the load storage device and the load handling device in the clean room.

According to Embodiment 2, a load can be readily and automatically moved between the load storage device and the load handling device in the clean room by the load transfer means.

Preferable Embodiment 3 of the load handling system of the present invention is characterized in that the load storage device has a rotary shelf, a fixed shelf, transfer means freely receiving and delivering a load between the shelves, and storing/retrieving means freely delivering a load by using the transfer means, the storing/retrieving means having an outer end positioned inside the clean room as a load take in/out section.

According to Embodiment 3, with the rotation of the rotary shelf, a load can be taken in and out on the rotary shelf by the transfer means. Further, the load can be taken in and out on the fixed shelf by the transfer means. Moreover, with the starting of the storing/retrieving means, the load can be taken in and out between the load take in/out section in the clean room and a delivering position of the transfer means. Therefore, the load storage device can be made compact on the whole. While the device is readily used for a clean room, etc., the height of the device can be fully utilized and a storing amount can be increased by the rotary shelf and the fixed shelf.

Embodiment 4 of the load handling system of the present invention is characterized in that the rotary shelf is rotatable around a rotary shelf axis in a vertical direction, a plurality of load receiving sections are provided on a rotary circular path having the rotary shelf axis at the center thereof, the transfer means is positioned laterally outside of the rotary shelf, a transfer operating section of the transfer means is provided rotatably around a transfer shaft in parallel with the rotary shelf axis, the transfer operating section is freely operable on a transfer circular path superimposed tangentially on the rotary circular path, the fixed shelf having load support sections is provided on the transfer circular path, the load receiving sections and the load support sections are provided on a plurality of vertically arranged stages, respectively, at least one of the rotary shelf and the fixed shelf is formed with a space from which the load receiving sections and the load support sections are eliminated, and the storing/retrieving means is provided using this space.

According to Embodiment 4, the rotary shelf is rotated around the rotary shelf axis to position a desired load receiving section on a superimposed part of the rotary circular path and the transfer circular path, so that a load can be taken in and out from the load receiving section by the transfer means. Further, the transfer operating section of the transfer means is rotated around the transfer axis, so that a load can be taken in and out from the load support sections of the fixed shelf by the transfer means.

As described above, since the transfer means only rotates the transfer operating section but does not perform traveling movement and so on, it is possible to eliminate the necessity for an occupied space for the transfer means to travel and so on, so that the entire structure can be formed compact including the rotary shelf and the fixed shelf. Additionally, a storing amount can be increased by the rotary shelf and the fixed shelf, and the transfer means having no configuration for travelling can lower the transfer operating section closer to the floor, so that the storing level of the rotary shelf and the fixed shelf can be lowered accordingly, thereby further increasing the storing amount. Therefore, it is possible to suitably and readily adopt the transfer means 51 for a place where a clean space such as a clean room needs be minimized.

In addition, while the height is fully utilized by a group of the load receiving sections of the rotary shelf and a group of the load support sections of the fixed shelf to increase the storing amount, a load can be always taken in and out smoothly to and from the outside without largely reducing the storing amount, owing to the storing/retrieving means provided by utilizing the space secured by eliminating the load receiving section and the load support section.

Preferable Embodiment 5 of the load handling system of the present invention is characterized in that the load is a cassette capable of storing a handled load.

According to Embodiment 5, storing in the load storage device and receiving and delivering in the clean room can be performed for each cassett storing the handled loads, so that the handled loads can be prevented from being adhered with dust and the like.

### BRIEF DESCRIPTION OF DRAWINGS

FIG. 1 is a perspective view showing a load handling system according to Example 1 of the present invention;

FIG. 2 is a plan view showing the load handling system;

FIG. 3 is an external perspective view showing a load storage device in the load handling system;

FIG. 4 is a longitudinal side view showing the load storage device in the load handling system;

FIG. 5 is a cross sectional plane view showing the load storage device in the load handling system;

FIG. 6 is a partially cutaway side view showing a lower part of a rotary shelf in the load storage device;

FIG. 7 is a partially cutaway side view showing an upper part of the rotary shelf in the load storage device;

FIG. 8 is a partially cutaway side view showing a lower part of transfer means in the load storage device;

FIG. 9 is a partially cutaway side view showing an upper part of the transfer means in the load storage device;

FIG. 10 is a partially cutaway plan view showing the transfer means in the load storage device;

FIG. 11 is a side view showing a fixed shelf in the load storage device;

FIG. 12 is a plan view showing the fixed shelf in the load storage device;

FIG. 13 is a schematic plan view showing storing/retrieving means in the load storage device;

FIG. 14 is a partially cutaway side view showing the storing means in the load storage device;

FIG. 15 is a partially cutaway front view showing delivery means to storage means in the load storage device;

FIG. 16 is a partially cutaway side view showing the storage means in the load storage device;

FIGS. 17 show Examples 2 to 4 of the present invention:, FIG. 17(A) being a schematic plan view showing Example 2; FIG. 17(B) being a schematic plan view showing Example 3; FIG. 17(C) being a schematic plan view showing Example 4; and

FIGS. 18 show Examples 5 and 6: FIG. 18 (A) being a schematic plan view showing Example 5; FIG. 18(B) being a schematic plan view showing Example 6.

### DETAILED DESCRIPTION

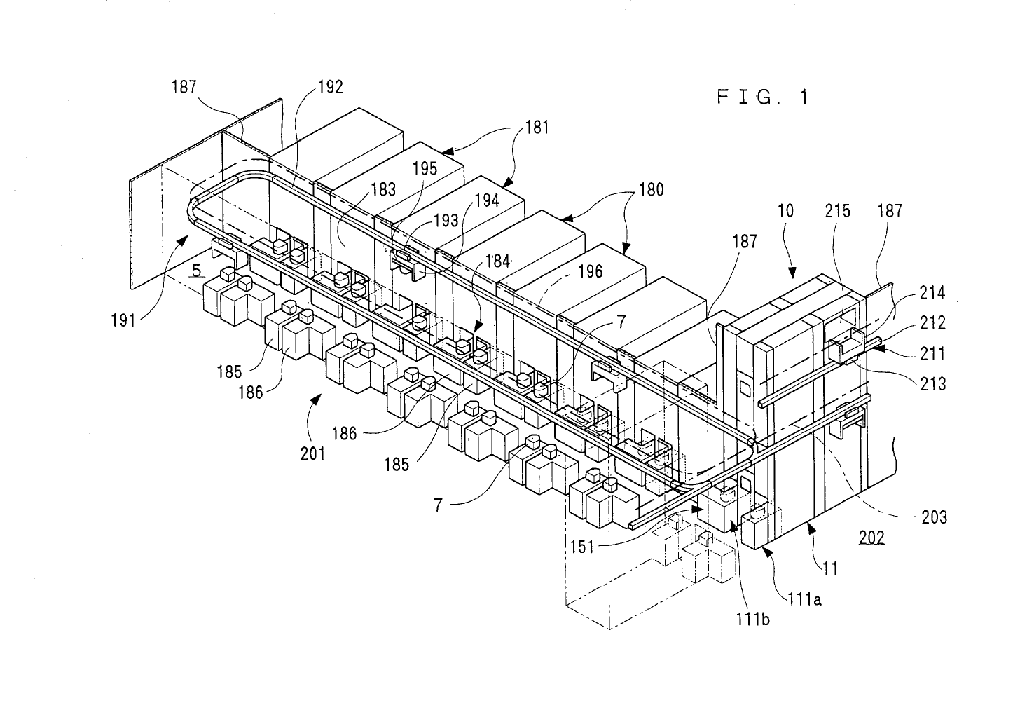

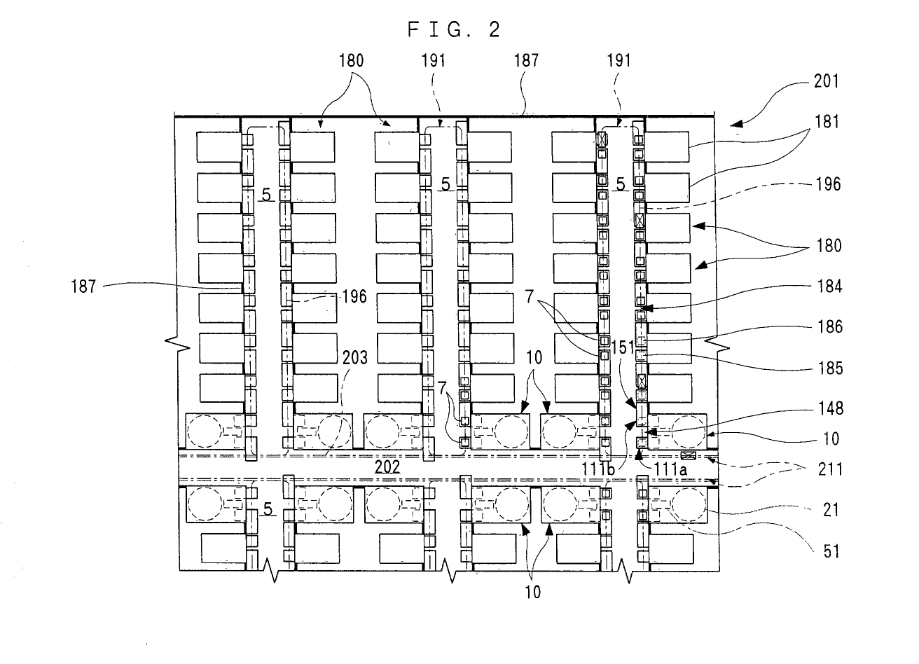

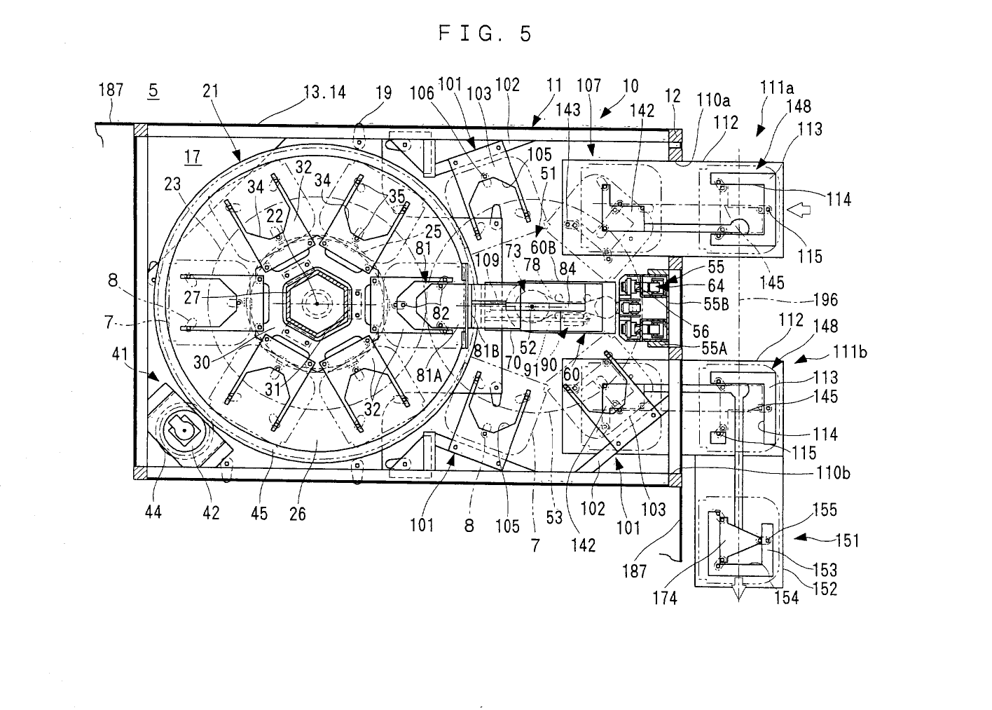

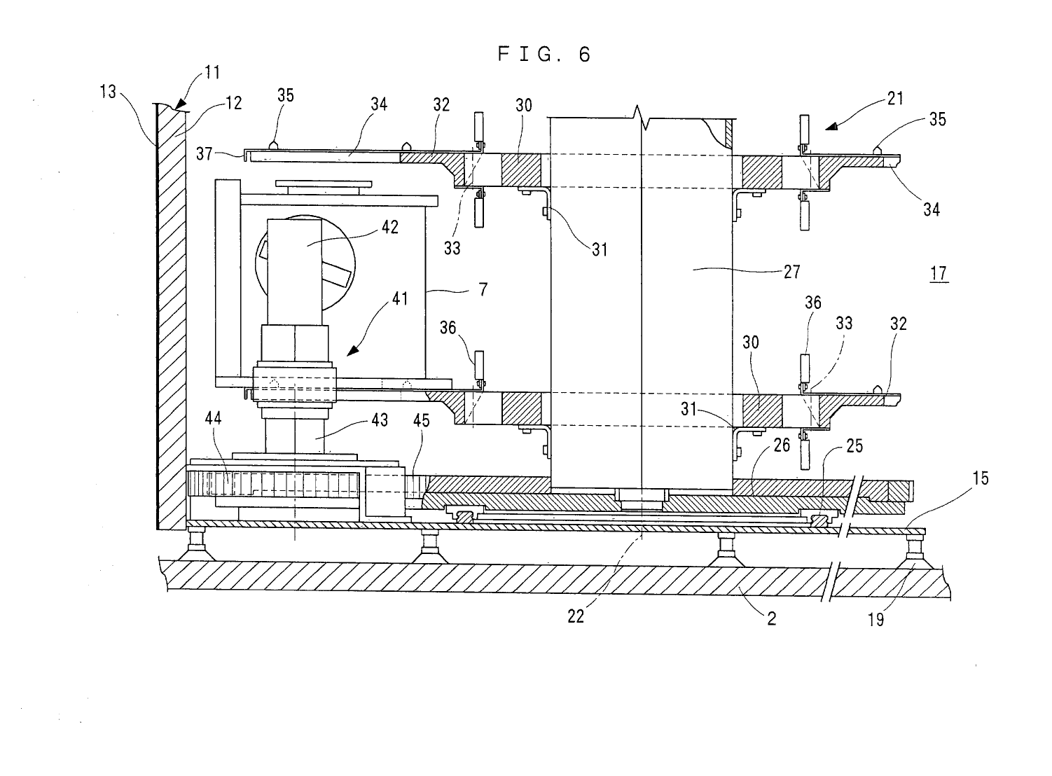

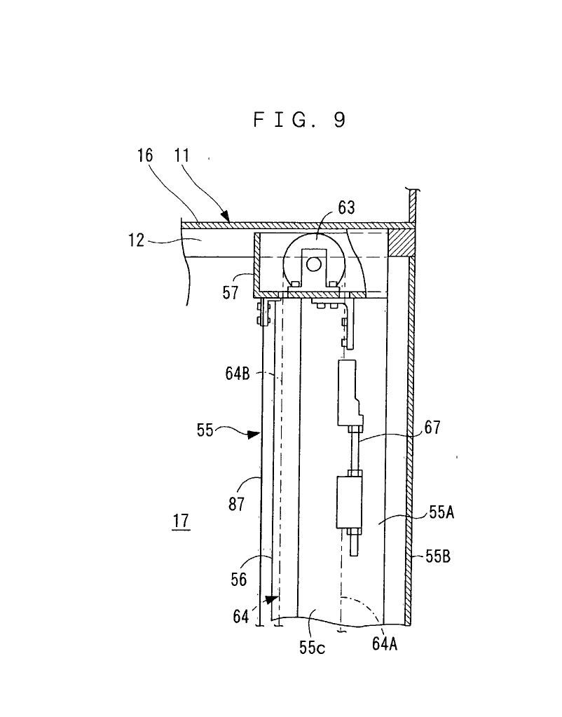

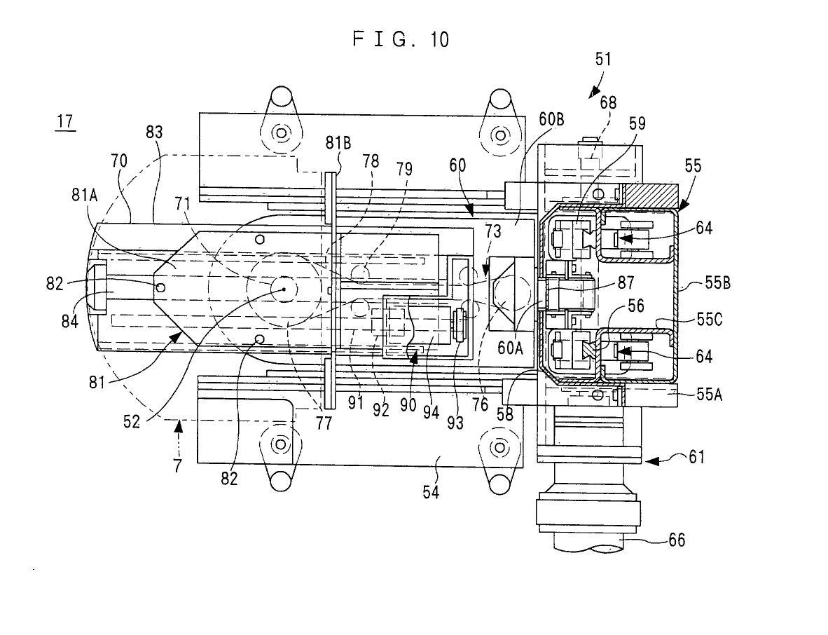

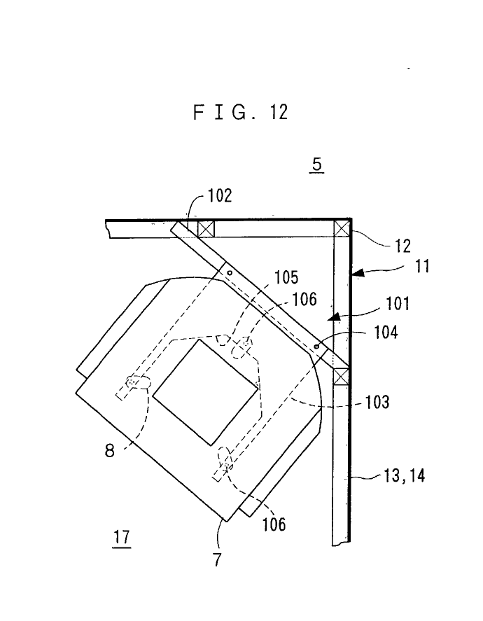

Referring to FIGS. 1 to 16, the following will discuss Example 1 of the present invention.

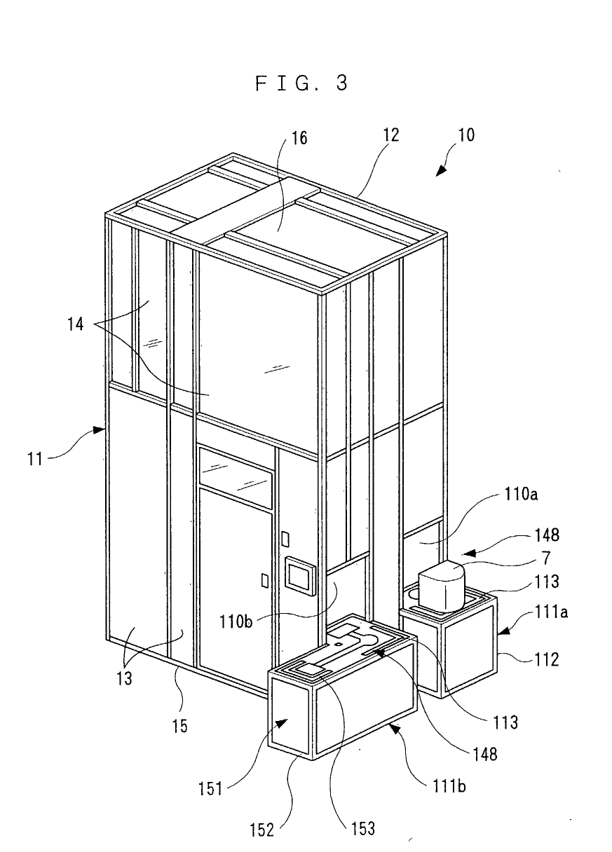

In FIGS. 3 to 5, a load storage device 10 is constituted by a surrounding wall body 11 formed into a rectangular box, a rotary shelf 21, transfer means 51, and fixed shelves 101 that are placed in the surrounding wall body 11, and storing and delivery means 111a and 111b which penetrate the surrounding wall body, and so on.

The surrounding wall body 11 is configured in a closed manner and is constituted by a frame body 12, a lower outer plate 13 attached to the outside and the lower half of the frame body 12, an upper outer plate 14 attached to the outside and the upper half of the frame body 12, a floor plate 15 attached to the bottom of the frame body 12, a ceiling plate 16 attached to the top of the frame body 12, and so on. In this case, at least for a part of the lower outer plate 13 and the upper outer plate 14, mainly for the upper outer plate 14, a transparent plate made of a resin and so on is used. Thus, the state of a load storage chamber (load storage space) 17 in the surrounding wall body 11 can be observed from the outside through the transparent plate. Here, the surrounding wall body 11 is placed on a floor 2 via legs 19 provided on the bottom of the floor plate 15.

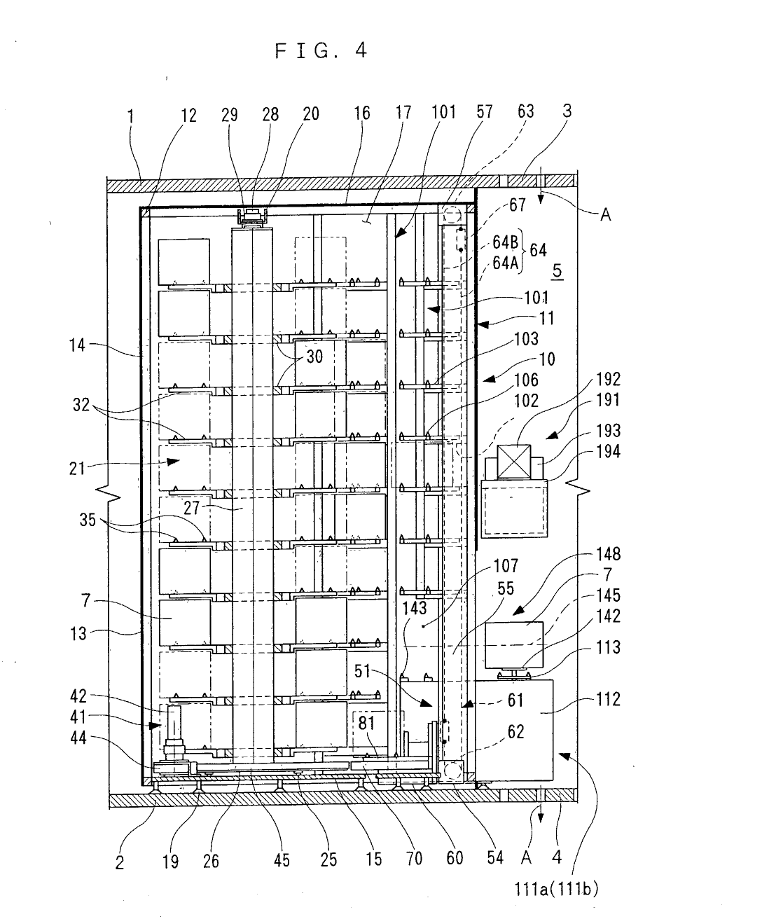

In FIGS. 4 to 7, the rotary shelf 21 is placed on one side of the load storage chamber 17. The rotary shelf 21 is rotatably placed around a rotary shelf axis 22 formed in a perpendicular direction, and a plurality of load receiving sections 32 are provided on a rotary circular path 23 having the rotary shelf axis 22 as the center.

On a bottom plate 15, a turning body 26 shaped like a disk is provided via circular LM guide means 25 having the rotary shelf axis 22 as the center. From the center of the rotating body 26, a vertical shaft body 27 shaped like a hexagonal cylinder is erected to be positioned on the rotary shelf axis 22, and a closing plate 27A is provided on the upper end of the vertical shaft body 27. Further, a vertical pin 28 erected from the center of the closing plate 27A is supported to freely rotate on a support plate 20 via a bearing device 29. The support plate 20 is provided in the upper part of the surrounding wall body 11.

Hexagonal annular plates 30 are fitted outside a plurality of points perpendicularly provided on the vertical shaft body 27, and the annular plates 30 are connected to the vertical shaft body 27 via a plurality of mounting members 31 and so on. The load receiving sections 32 are placed on six points (a plurality of points) in a peripheral direction of the annular plates 30. The load receiving sections 32 are formed into plate frames, and the base ends are connected to the annular plates 30 via connecting members 33, so that the load receiving sections 32 are supported on the annular plates 30 in a cantilevered manner to protrude laterally to the outside.

Moreover, concave sections 34 opened vertically and to rotating ends (outside) are formed on the load receiving sections 32, and positioning pins 35 are erected from three points (one or more points) around the concave sections 34. Also, reflection mirrors 36 constituting a part of load detection means are provided on the base ends of the load receiving sections 32, and reflection tapes 37 constituting a part of the load detection means are provided on the rotating ends of the load receiving sections 32.

Rotary shelf driving means 41 is provided for rotating the rotary shelf 21. To be specific, a rotary driving section 42 is provided on a corner of the bottom plate 15, and a driving gear 44 is provided on a driving shaft 43 provided downward from the rotary driving section 42. And then, a ring gear 45 is provided on the outer edge of the turning body 26, the driving gear 44 is engaged to the ring gear 45 all the time. Here, the rotary driving section 42 is composed of a motor, a speed reducer, and so on and is configured to drive the driving shaft 43 forward and backward.

Therefore, the driving shaft 43 is driven in a reverse manner by the rotary driving section 42 of the rotary shelf driving means 41, so that the rotary shelf 21 can be rotated around the rotary shelf axis 22 in a reverse manner via the driving gear 44, the ring gear 45, and so on. At this moment, the rotary shelf 21 is configured to rotate 180° at the maximum. The above-described members 22 to 45 constitute an example of the rotary shelf 21.

In FIGS. 4, 5, 8 to 10, the transfer means 51 is placed on the other side in the load storage chamber 17. A transfer operating section 81 of the transfer means 51 is rotatably provided around a transfer shaft 52, which is provided in parallel with the rotary shelf axis 22, and is freely operable on a transfer circular path 53, which is superimposed on the rotary circular path 23 as a tangent line.

To be specific, a base frame 54 is formed on the bottom plate 15, a post body 55 is erected from the base frame 54, and guide rail 56 is provided on the front side of the post body 55. Here, the post body 55 is constituted by a pair of side members 55A provided laterally, a rear member 55B provided between the inner sides of the side members 55A, and front members 55C provided on the front side of the rear member 55B. The guide rails 56 are provided on the front side of the front member 55C. Further, an upper frame 57 is provided on the upper end of the post body 55, and cover members 58 are respectively provided on the front members 55C.

A lifting/lowering to 60 is provided, which is guided to the guide rails 56 via a guided body 59 to freely ascend and descend (LM guide), and lifting/lowering driving means 61 in synchronization with the lifting/lowering to 60. To be specific, the lifting/lowering to 60 is formed like a letter L taken from the side. The lifting/lowering to 60 is constituted by a vertical member 60A connected to the side of the guided body 59, and a lateral member 60B connected to the front from the lower end of the vertical member 60A.

The lifting/lowering driving means 61 is constituted by a drive wheel 62 provided in the base frame 54, a driven wheel 63 provided on a part of the upper frame 57, and an endless turning body (timing belt, etc.) 64 wound between the wheels 62 and 63, a guide wheel 65 provided near the drive wheel 62, a rotating driving to 66 in synchronization with the drive wheel 62, and so on. Here, the rings 62, 63, and 65 are provided laterally in pairs, and the turning body 64 is also provided laterally in pairs.

In this case, each of the rotating members 64 comprises a lower rotating to 64A wound around the drive wheel 62, and an upper rotating to 64B wound around the driven ring 63. Moreover, the rotating ends positioned on the front side of the post body 55 are connected to the guided body 59, and the rotating ends positioned on the rear side are connected via a tension adjusting member 67. The rotary driving section 66 is constituted by a motor capable of reverse driving, a speed reducer, and so on. A pair of drive wheels 62 are mounted on a driving shaft 68 of the driving to 66.

A rotating body 70 is provided on the lateral member 60B of the lifting/lowering to 60 to freely rotate around the transfer shaft 52, and at this moment, a vertical shaft 71 vertically provided from the center of the rotating body 70 is rotatably supported by a bearing 72 on the side of the lateral member 60B. Moreover, a rotation driving means 73 is provided to be connected to the vertical shaft 71.

To be specific, the rotation driving means 73 is constituted by a rotary driving section 74 provided from the vertical member 60A to the lateral member 60B, a drive wheel 76 attached to a driving shaft 75 provided under the rotary driving section 74, a driven ring 77 attached to the vertical shaft 71, an endless turning body (timing belt, etc.) 78 wound between the ring bodies 76 and 77, a plurality of guide rings 79 provided in the lateral member 60B, and so on. Here, the rotary driving section 74 is constituted by a motor capable of reverse driving, a speed reducer, and so on.

The transfer operating section 81 is provided in a fork form and is placed to freely protrude and retract (laterally) with respect to the rotating body 70, and thus is provided rotatably around the transfer shaft 52. To be specific, the transfer operating section 81 is constituted by a support plate 81A provided in a forward and backward direction, and a displacement regulating plate 81B erected from the intermediate point of the support plate 81A, and so on. Further, in front of the displacement regulating plate 81B, positioning pins 82 are erected on a plurality of points of the support plate 81A.

A pair of rail members provided laterally are placed forward and backward on the rotating body 70, and a guide body 84 provided forward and backward is placed at the center in a lateral direction between the rail members 83. Moreover, a guided body 85, which is fitted outside the guide body 84 and constitutes an LM guide, is provided on a rear end and a lower surface of the support plate 81A.

An protruding/retracting drive means 90 is provided for protruding and retracting the transfer operating section 81 in forward and backward directions. To be specific, the protruding/retracting drive means 90 is constitute by a screw shaft 91 provided along the guide body 84, a nut body 92 which is provided on the lower surface of the transfer operating section 81 and is screwed into the screw shaft 91, a rotary driving section 94 which is mounted on the rotating body 70 and is connected to the screw shaft 91 via a belt interlocking mechanism, and so on. Here, the rotary driving section 94 is constituted by a motor capable of reverse driving, a speed reducer, and so on.

Besides, the support plate 81A of the transfer operating section 81 is configured to freely move up and down with respect to a concave section 34 of the load receiving section 32. Further, a dustproof belt 87 which allows the guided body 59 to move up and down and can close a gap between cover bodies 58 is provided on a part of the post body 55, and a dustproof belt 88 which allows the transfer operating section 81 to move forward and backward and can close the top of the guide body 84 is provided on a part of the rotating body 70.

The above-described members 52 to 94 and so on constitute an example of the transfer means 51. Moreover, the transfer operating section 81 of the transfer means 51 is provided to freely rotate around the transfer shaft 52 provided in parallel with the rotary shelf axis 22, and is freely operable on the transfer circular path 53, which is superimposed on the rotary circular path 23 as a tangent line.

In FIGS. 4, 5, 11, and 12, the fixed shelves 101 are provided at four points (one or more points) on the transfer circular path 53 on the other side in the load storage chamber 17. Namely, in the surrounding wall body 11, flat bars 102 provided in a lateral direction are connected to a plurality of points in a vertical direction of the frame body 12, and load support sections 103 are provided on the flat bars 102, respectively. The load support sections 103 are shaped like plate frames and has base ends which are connected to the flat bars 102 via connecting members 104 and are thus supported by the flat bars 102 in a cantilevered manner to protrude forward in a lateral direction.

Further, concave sections 105 opened vertically and to the rotating ends (outside) are formed on the load support sections 103, and positioning pins 106 are erected from three points (one or more points) around the concave sections 105. Additionally, the support plate 81A of the transfer operating section 81 is configured to freely move up and down with respect to the concave sections 105. The above-described members 102 to 106 and so on constitute an example of a fixed shelf 101.

In FIGS. 3 to 5 and 12 to 16, among the fixed shelves 101 provided on the four points on the transfer circular path 53, on lower parts of the fixed shelves 101 on two points (one or more points) apart from the rotary shelf 21, spaces 107 are formed by eliminating the load support sections 103 by three stages from the bottom (a plurality of stages from the bottom). And then, the spaces 107 are used to form storing/retrieving means which can freely deliver loads to the transfer means 51. In this case, storing/retrieving directions of the storing/retrieving means are provided in parallel with a line 109, which connects the rotary shelf axis 22 and the transfer shaft 52.

To be specific, on the lower outer plate 13 on the other side of the surrounding wall body 11, a penetrated receiving section 110a and a penetrated delivery section 110b are formed to be opposed to the spaces 107, and storing means (storing/retrieving means) 111a and delivery means (storing/retrieving means) 111b are provided inside and outside the surrounding wall body 11 through the penetrated sections 110a and 110b.

Here, the storing means 111a and the delivery means 111b are identical to each other in configuration and respectively have main bodies 112 which are shaped like box frames and are provided inside and outside the surrounding wall body 11. Temporary receiving bodies 113 are provided on the outer ends of the main bodies 112. The temporary receiving body 113 is formed in a single plate or a divided plate and has a lifting/lowering operating section 114 formed into a concave section or a penetrated lifting/lowering operating section. Positioning pins 115 are erected from three points (one or more points) around the lifting/lowering operating section 114.

In the main body 112, a moving member 117, which is supported and guided by the guide body 116 to freely move in inner and outer directions (forward and backward directions), and a moving device 118 for moving the moving member 117 in inner and outer directions.

Here, the moving device 118 is constituted by a driving lifting/lowering operating (motor or the like) 119 provided on the side of the moving member 117, a timing pulley 121 attached to an output shaft 120 provided laterally from the driving lifting/lowering operating 119, guide pulleys 122 which are provided at two points in inner and outer directions above the timing pulley 121 to freely rotate on the side of the moving member 117, a timing belt 123 looped over the timing pulley 121 and the guide pulleys 122, and so on. Here, both ends of the timing belt 123 are fixed on inner and outer ends 124 on the side of the main body 112.

A lifting/lowering unit 125 is provided in the moving member 117. The lifting/lowering unit 125 is constituted by a screw shaft 127 rotatably provided on the side of the moving member 117 via a bearing 126, a driving lifting/lowering operating (motor or the like) 128 which is provided on the side of the moving member 117 and is capable of reverse driving, an endless interlocking mechanism 130 provided between an output shaft 129, which is provided downward from the driving lifting/lowering operating 128, and the screw shaft 127, a nut body 131 screwed into the screw shaft 127, a guide mechanism 132 which is provided between the moving member 117 and the nut body 131 to lift and guide the nut body 131, and so on. Lifting/lowering members 133 are connected to the nut body 131.

A turning device 135 is provided on the lifting/lowering members 133. The turning device 135 is constituted by a bracket 136 connected to the lifting/lowering members 133, a vertical shaft 138 rotatably provided on the bracket 136 via a bearing 137, a driving lifting/lowering operating (motor or the like) 139 which is provided on the bracket 136 and is capable of reverse driving, an endless interlocking mechanism 141 provided between an output shaft 140, which is provided up from the driving lifting/lowering operating 139, and the shaft 138, and so on. A lifting/lowering body 142 is connected to the upper end of the shaft 138. Here, the lifting/lowering body 142 is formed into a plate and is configured to freely fit in the lifting/lowering operating section 114 of the temporary receiving body 113.

Besides, on the inner end of the main body 112, positioning pins 143 are erected from predetermined three points (one or more points). The main body 112 and so on is provided at right angles to the penetrated sections 110a and 110b, and a delivering and receiving direction 145 of the storing means 111a and the delivery means 111b is thus provided in parallel with the line 109, which connects the rotary shelf axis 22 and the transfer shaft 52. The above-described members 112 to 145 and so on constitute examples of the storing means 111a and the delivery means 111b.

Storage means 151 is integrally provided on the side of the outer end of the delivery means 111b. To be specific, a main body 152, which is formed into a box frame integrally with the main body 112, is shaped like a letter L on a plane by the main body 112. A temporary receiving body 153 is provided on the rotating end (apart from the delivery means 111b) on the main body 152. The temporary receiving body 153 is formed into a plate and has a lifting/lowering operating section 154 formed by making a concave section. Positioning pins 155 are erected from three points (one or more points) around the lifting/lowering operating section 154.

In the main body 152, a moving member 157, which is supported and guided by a guide body 156 to freely move in a lateral direction, and a moving device 158 for moving the moving member 157 in inner and outer directions. Here, the moving device 158 is similar to the moving device 118 and is constituted by a driving part 159, an output shaft 160, a timing pulley 161, and guide pulleys 162, a timing belt 163, and so on. Further, both ends of the timing belt 163 are fixed to ends 164 on the side of the main body 152.

A lifting/lowering unit 165 is provided in the moving member 157. The lifting/lowering unit 165 is similar to the lifting/lowering unit 125 and is constituted by a bearing 166, a screw shaft 167, a driving part 168, an output shaft 169, an endless interlocking mechanism 170, a nut body 171, a guide mechanism 172, and so on. Moreover, a lifting/lowering body 174 is connected to the nut body 171 via a lifting/lowering member 173. Here, the lifting/lowering body 174 is formed into a plate and is configured to be freely fitted to the lifting/lowering operating section 114 and 154 of the temporary receiving bodies 113 and 153. The above-described members 152 to 174 and so on constitute an example of the storage means 151.

As described above, the rotary shelf 21, the transfer means 51, and the fixed shelves 101 are provided in the surrounding wall body 11. Each of the rotary shelf 21, the transfer means 5 1, and the fixed shelves 101 is provided as a single member like both of the rotary circular path 23 and the transfer circular path 53. Further, the fixed shelves 101 are provided at four points (a plurality of points) on the transfer circular path 53.

Moreover, load receiving section groups 32 are provided on a plurality of vertical stages in the rotary shelf 21, and load support sections 103 are provided on a plurality of vertical stages in the fixed shelf 101. Further, the transfer means 51 operates on the plurality of vertical stages of the rotary shelf 21 and the fixed shelf 101. Besides, on the lower surfaces of cassettes (an example of a load) 7, fitting parts 8 permitting the groups of the positioning pins 35, 82, 106, 115, 143, 155 to be fitted are formed into concave and long holes. Here, the cassettes 7 store handled loads (not shown).

In FIGS. 1 to 3, the load storage device 10 has load take in/out sections 148 formed by the outer ends of the storing means 111a and the delivery means 111b on an outer part of the lower outer plate (outer plate) 13. In such a load storage device 10, the load take in/out sections 148 are provided in a pair to be opposed to each other with a predetermined spacing. Moreover, a plurality of load handling devices 180 are provided on the side of the load storage devices 10 at predetermined intervals. Here, the load handling devices 180 are provided at predetermined intervals in the same direction as the load storage devices 10. Thus, the groups of the load handling devices 180 are opposed to one another at the above-described predetermined spacing.

The load handling device 180 has a handling chamber 182 in an surrounding wall body 181, and a various kinds of handling means (not shown) are provided in the handling chamber 182. Load take in/out sections 184 are formed on the outside of an outer plate 183 serving as a front plate of the surrounding wall body 181, and the load take in/out section 184 is constituted by a carry-in device 185, a carry-out device 186, and so on.

Partition walls 187 are provided on the outer plates 13, 14, 183, and so on between the load storage device 10 and the group of the load handling devices 180. A region surrounded by the partition walls 187 and so on, that is, the above-described predetermined space is formed as a clean room 5. Hence, the load storage device 10 and the load handling device 180 are configured that the outer plates 13, 14, 183 thereof are used also as part of the partition walls 187, and the load take in/out sections 118 and 184 formed on these outer plates 13 and 183 are provided to face the clean room 5.

The clean room 5 is configured such that a filter 3 is provided on a ceiling 1 and a grating floor (porous plate) 4 for suction is provided on a floor 2. Hence, a down-flow type is used in which clean air A is discharged through the filter 3 and the clean air A is sucked through the grating floor 4. Thus, the inside of the clean room 5 is brought into a clean atmosphere.

In the clean room 5, load transfer means 191 is provided for delivering the cassettes 7 between the load storage device 10 and the load handling device 180, and is configured to deliver the cassettes 7 in the clean room 5.

The load transfer means 191 is constituted by a rail device 192 on the ceiling, a moving body 193, which is supported and guided by the rail device 192 and automatically travels in a lifted travel mode, a load holding section 194 provided on the lower part of the moving body 193, and so on. Further, a load hanging device 195 is provided on the load holding part 194 to freely move up and down. Here, a transfer path 196 operated by the load transfer means 191 is formed endlessly to connect an upper interval of the load take in/out sections 118 and 184.

A plurality of load handling systems 201 are provided such that the clean rooms 5 are connected via a connection clean room 202. The load handling system 201 is constituted by the load storage device 10, the load handling device 180, the load transfer means 191, and so on. Further, between the load handling systems 201, the transfer paths 196 are connected via a connection path 203.

Upper transfer means 211 passing outside of the upper outer plate 14 of the load storage device 10 is provided above the connection path 203 and so on. To be specific, the upper transfer means 211 is constituted by a rail device 212 on the ceiling, a moving body 213, which is supported and guided by the rail device 212 and can travel automatically, a load support section 214 provided on the upper part of the moving body 213, and so on. Here, the load support section 214 is provided, for example, in a fork form.

A load passing part 215 for delivering the cassettes 7 to the transfer means 211 is formed on the upper outer plate 14 of the surrounding wall body 11. To be specific, the load passing part 215 is formed by an opening on the upper outer plate 14 on the side near the rotary shelf 21. Further, the load support section 214 of the moving body 213 is subjected to fork movement via the load passing part 215, so that the cassettes 7 can be freely delivered to the target load receiving section 32.

Besides, delivering means may be provided, for example, in a fork form on a part of the load passing part 215 to freely deliver the cassettes 7 to the load support section 214 of the moving body 213. Additionally, the transfer means 211 and the like may be eliminated.

The following will discuss the operation in the above described Example 1.

In the clean room 5 and the connection clean room 202, clean air A discharged through the filter 3 on the ceiling 1 is discharged under the grating floor 4, so that a clean atmosphere is maintained by the down-flow type. In order to carry the cassette 7 into the load storage device 10 and to store it therein by using such a clean room 5, the cassette 7 to be carried is placed on the leading end (outer end) of the storing means 111a.

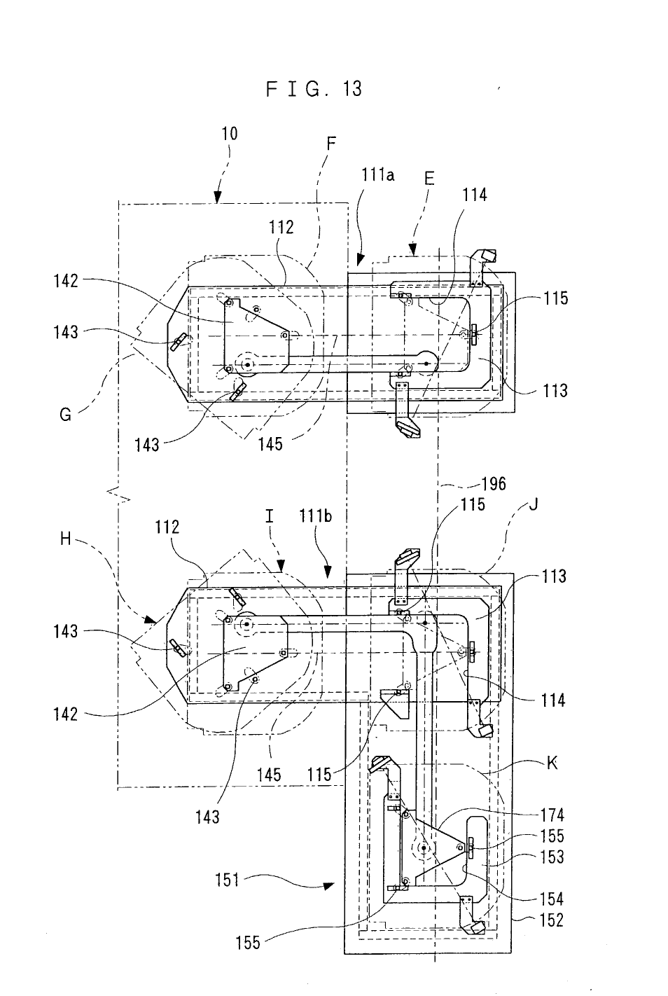

To be specific, as shown in E of FIG. 13, the cassette 7 to be carried is placed on the temporary receiving body 113 on the storing means 111a by starting the load transfer means 191, and the fitting parts 8 are fitted to the positioning pins 115. Before and after the fitting, the lifting/lowering body 142 which moves down in a proper position is positioned below the lifting/lowering operating section 114.

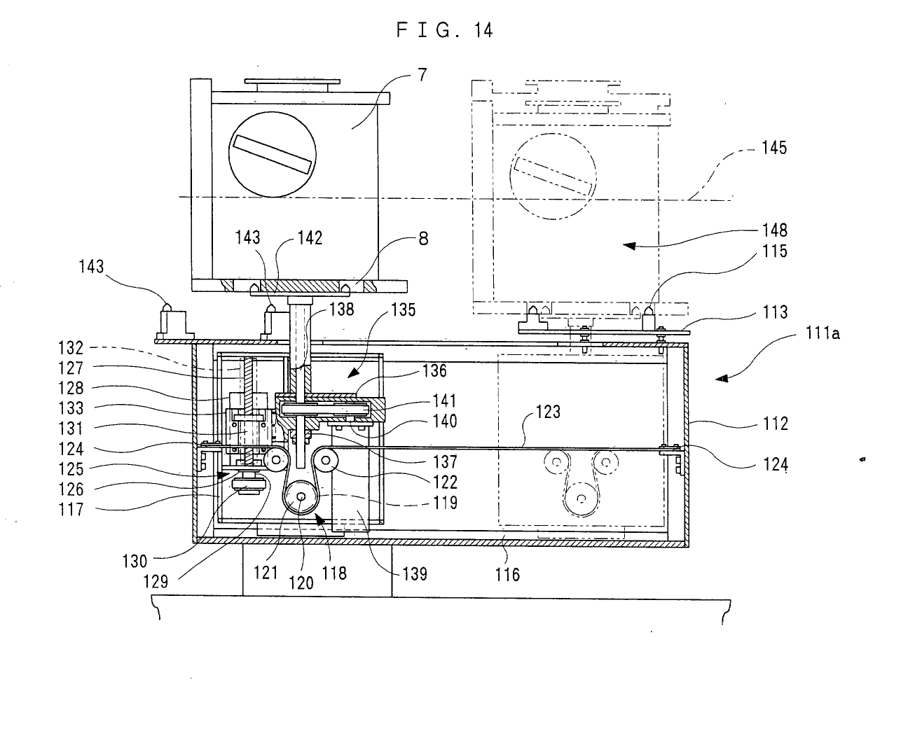

In this state, first, the driving part 128 of the lifting/lowering unit 125 is started to rotate the screw shaft 127 via the endless interlocking mechanism 130 and so on. And then, the nut body 131 is lifted in response to the rotation of the screw shaft 127, the turning device 135 is lifted via the lifting/lowering member 133, and the lifting/lowering body 142 connected to the shaft 138 on the side of the turning device 135 is lifted accordingly. The ascending lifting/lowering body 142 passes through the lifting/lowering operating section 114 and lifts the cassette 7 on the temporary receiving body 113 as indicated by virtual lines shown in FIG. 14.

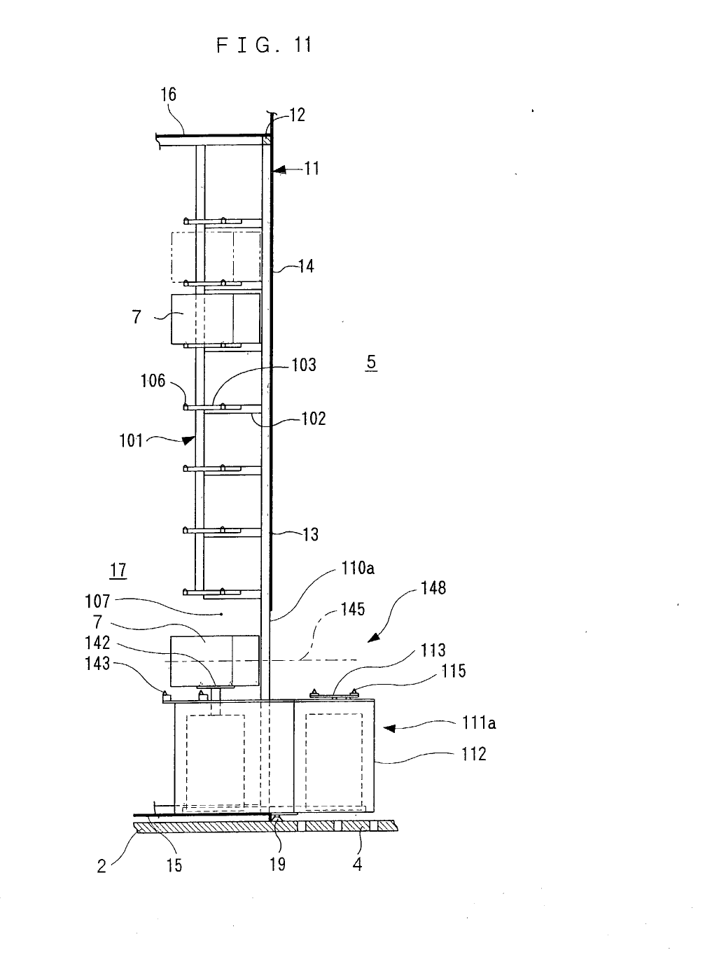

Next, the driving part 119 of the moving device 118 is started to drive and rotate the timing pulley 121, where the timing belt 123 is looped, so that the moving member 117 is moved to the terminal end (inner end) of the storing means 111a while being supported and guided by the guide body 116. At this moment, the lifting/lowering body 142 is also moved via the lifting/lowering unit 125 and the turning device 135, the cassette 7 is carried into the surrounding wall body 11 through the penetrated receiving section 110a, and then, as indicated by F of FIG. 13 and the solid lines of FIG. 14, the cassette 7 is stopped at the terminal end. Thus, as shown in FIG. 11, the cassette 7 can be positioned on the space 107 and so on which is formed on the lower part of the fixed shelf 101.

And then, the driving part 139 of the turning device 135 is started, the shaft 138 is rotated via the endless interlocking mechanism 141 and the like, and thus, as indicated by G of FIG. 13, the direction of the cassette 7 is changed to an tilting direction via the lifting/lowering body 142. Namely, the cassette 7 is changed in direction to be supported by the load support sections 103 of the fixed shelf 101.

Subsequently, the driving part 128 of the lifting/lowering unit 125 is operated in reverse, and the rotation of the screw shaft 127 is reversed via the endless interlocking mechanism 130 and so on. And then, the nut body 131 is moved down in response to the reverse rotation of the screw shaft 127, the turning device 135 is moved down via the lifting/lowering member 133, and the lifting/lowering body 142 connected to the shaft 138 on the side of the turning device 135 is moved down. The lifting/lowering body 142, which is moved down, passes between the positioning pins 143, and the cassette 7 is thus placed on the side of the main body 112 in a state in which the fitting parts 8 are fitted to the positioning pins 143.

And then, the driving part 139 of the turning device 135 is operated in reverse, the rotation of the shaft 138 is reversed via the endless interlocking mechanism 141 and the like, and the direction of the lifting/lowering body 142 is changed to a normal attitude. Subsequently, the driving part 119 of the transfer device 118 is operated in reverse and the timing pulley 121, on which the timing belt 123 is looped, is driven and rotated in reverse, so that the moving member 117 is moved to the leading end (outer end) of the storing means 111a. At this moment, the lifting/lowering body 142 is also moved via the lifting/lowering unit 125 and the turning device 135, and the lifting/lowering body 142, which is moved down in a normal attitude, is positioned below the lifting/lowering operating section 114 to return to an initial state.

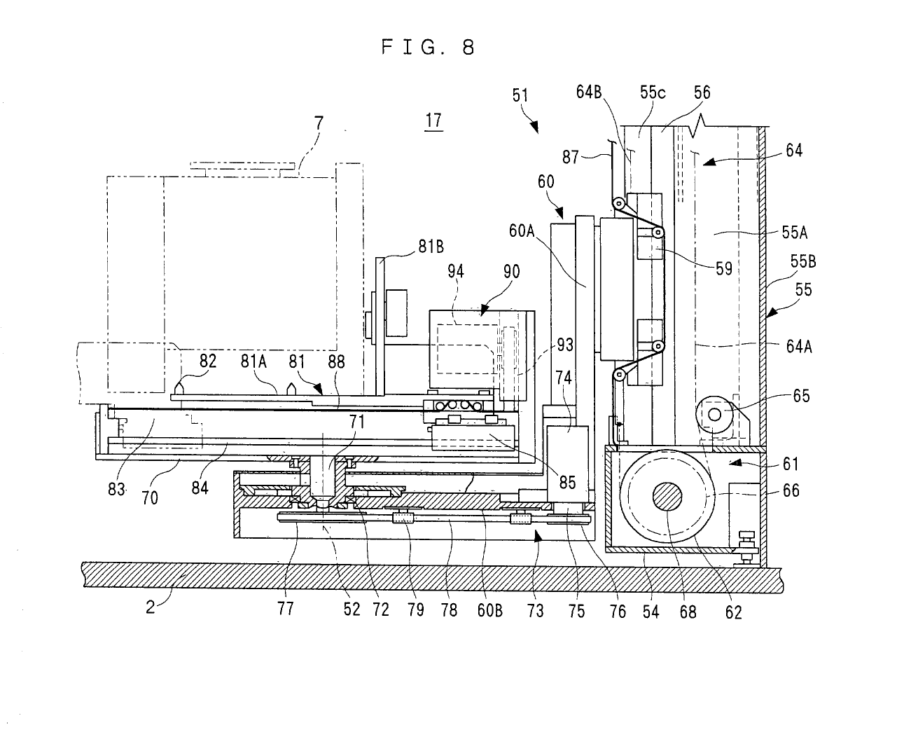

And then, the cassette 7 positioned on the inner end of the storing means 111a is received by the transfer means 51. At this moment, as indicated by a solid line of FIG. 8, the rotating and lifting/lowering of the vacant transfer operating section 81 are simultaneously performed or any one of them is firstly performed in a state in which the transfer operating section 81 is retracted into the rotating body 70.

Namely, when the transfer operating section 81 is rotated, the rotary driving section 74 in the rotation driving means 73 is normally and reversely driven, and the drive wheel 76 is normally and reversely rotated via the driving shaft 75. Thus, the rotation of the vertical shaft 71 can be reversed via the endless turning body and the driven ring 77, and accordingly, the transfer operating section 81 can be normally and reversely rotated around the transfer shaft 52 via the rotating body 70.

Further, when the transfer operating section 81 is moved up and down, the rotary driving section 66 in the lifting/lowering driving means 61 is normally and reversely driven, and the drive wheel 62 is normally and reversely rotated via the driving shaft 68. Hence, the turning body 64 can be normally and reversely rotated, and the transfer operating section 81 can be moved up and down via the guided body 59 and the lifting/lowering section 60. Since the transfer operating section 81 is rotated and moved up and down in this manner, the transfer operating section 81 can be opposed to the inner end of the storing means 111a at a slightly lower level.

Subsequently, the transfer operating section 81 is retracted. To be specific, the rotary driving section 94 in the protruding/retracting drive means 90 is driven, and the screw shaft 91 is rotated via the belt interlocking mechanism 93. Thus, the nut body 92 is screwed and moved to retract the transfer operating section 81. At this moment, the guided body 85 is guided by the guide body 84, so that the transfer operating section 81 can protrude linearly as indicated by a virtual line of FIG. 8. With this protrusion, the transfer operating section 81 can be positioned below the cassette 7 placed on the inner end of the storing means 111a.

In this state, the transfer operating section 81 is slightly moved up by the abovedescribed operation of the lifting/lowering driving means 61 via the lifting/lowering section 60 and the like. And then, the transfer operating section 81 is moves up the inner end of the main body 112 in the storing means 111a to lift the cassette 7 positioned on the inner end of the storing means 111a. At this moment, the positioning pins 82 are fitted to the fitting sections 8. And then, the protruding/retracting drive means 90 is operated in reverse from the above-described operation to retract the transfer operating section 81, so that the cassette 7 can be positioned above the turning body 70.

And then, the transfer operating section 81 is rotated as described above and is moved up and down as necessary, so that the cassette 7 can be opposed to the desired load support section 103 of the desired fixed shelf 101. At this moment, the transfer operating section 81 is positioned slightly higher than the load support section 103.

And then, the transfer operating section 81 is protruded as described above to position the cassette 7 above the load support section 103. Subsequently, the transfer operating section 81 is slightly moved down to place the cassette 7 on the load support section 103. At this moment, the fitting sections are fitted to the positioning pins 106, and then, the transfer operating section 81 is retracted. Hence, the cassette 7 positioned on the inner end of the storing means 111a can be taken into the fixed shelf 101. Namely, the transfer operation is ended, in which the cassette 7 supplied to the storing means 111a is taken into the load support section 103 of the fixed shelf 101, which is provided on the transfer circular path 53.

Moreover, the cassette 7 positioned on the inner end of the storing means 111a can be also taken into the rotary shelf 21. That is, during the operation for receiving the cassette 7, which is positioned on the inner end of the storing means 111a as described above, in the transfer means 51, the rotary shelf 21 is rotated and prepared in advance.

The rotation of the rotary shelf 21 normally and reversely rotates the rotary driving section 42 in the rotary shelf driving means 41, and the driving gear 44 is normally and reversely rotated via the driving shaft 43. Hence, the ring gear 45 can be normally and reversely rotated, and a group of the load receiving sections 32 can be thus rotated around the rotary shelf axis 22 via the vertical shaft 27 and so on. At this moment, the group of the load receiving sections 32 is rotated and moved on the rotary circular path 23. When the desired load receiving section 32 reaches a position superimposed on the transfer circular path 53 as a tangent line, the rotation of the load receiving section 32 is stopped.

Additionally, the rotary shelf 21 is rotated normally or reversely to a shorter rotating distance of the desired load receiving section 32 from the above superimposing position at 180° at the maximum, so that rotation can be made quickly and efficiently. Further, the rotary shelf 21 is rotated and prepared in advance during the receiving operation of the transfer means 51, the operating efficiency can be entirely improved. Besides, when the desired load receiving section 32 is on the superimposed position from the start, the rotary shelf 21 is not rotated.

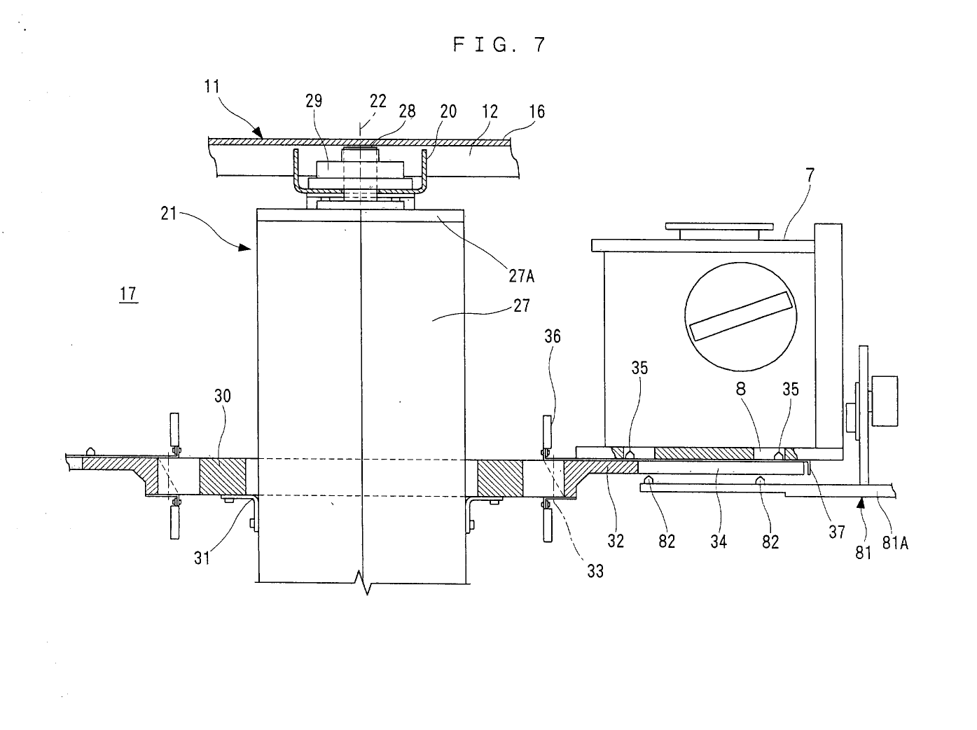

As described above, after the desired load receiving section 32 is stopped at the superimposed position, the transfer means 51 is operated as discussed above, so that the cassette 7 supported by the transfer operating section 81 can be placed on the load receiving section 32 as shown in FIGS. 4 and 7. At this moment, the fitting sections 8 are fitted to the positioning pins 35. Hence, the cassette 7 positioned on the inner end of the storing means 111a can be placed on the desired load receiving section 32 of the rotary shelf 21, and accordingly, the operation for taking the cassette 7, which is supplied to the storing means 111a, into the rotary shelf 21 is ended.

Besides, the cassette 7 stored in the fixed shelf 101 can be similarly transferred to the rotary shelf 21 and stored therein by operating the transfer means 51 and rotating the rotary shelf 21. At this moment, the rotary shelf 21 is rotated and prepared in advance during an operation for receiving the cassette 7 of the fixed shelf 101 by the transfer means 51, to that the operating efficiency can be entirely improved. Additionally, when the desired load receiving section 32 is on the superimposed position from the start, the rotary shelf 21 is not rotated.

The transfer means 51 is operated in reverse, the operation for taking out the cassette 7 can be performed, the cassette 7 place on the desired load receiving section 32 of the rotary shelf 21 can be placed on the leading end (inner end) of the delivery means 111b, and the cassette 7 placed on the desired load support section 103 of the desired fixed shelf 101 can be positioned on the leading end of the delivery means 111b.

Namely, as indicated by H of FIG. 13, the operation of the transfer means 51 is firstly operated to place the cassette 7 on the leading end of the main body 112 in the delivery means 111b in a state in which the fitting sections 8 are fitted by the positioning pins 143. Next, the delivery means 111b is operated in a substantially reversed manner from the storing means 111a. Namely, the lifting/lowering body 142 changed to a tilting direction is moved up to lift the cassette 7.

And then, as indicated by I of FIG. 13, after the direction of the lifting/lowering body 142 is changed to a normal attitude, the cassette 7 is moved to the terminal end (outer end) of the delivery means 111b while the moving member 117 is supported and guided by the guide body 116. At this moment, the lifting/lowering body 142 is also moved via the lifting/lowering unit 125 and the turning device 135, and the cassette 7 is thus stopped at the terminal end of the delivery means 111b as indicated by J of FIG. 13 after being taken out of the surrounding wall body 11 via the penetrated delivery section 110b.

Next, the lifting/lowering body 142 is moved down via the lifting/lowering operating section 114 of the temporary receiving body 113, and the cassette 7 is placed on the side of the temporary receiving body 113 in a state in which the fitting sections 8 are fitted to the positioning pins 115. In this way, the cassette 7 is positioned on the terminal end (outer end) of the delivery means 111b to complete the delivery operation.

Besides, the cassette 7 stored in the rotary shelf 21 can be also transferred (taken out) to the fixed shelf 101 in this manner by operating the transfer means 51 and rotating the rotary shelf 21.

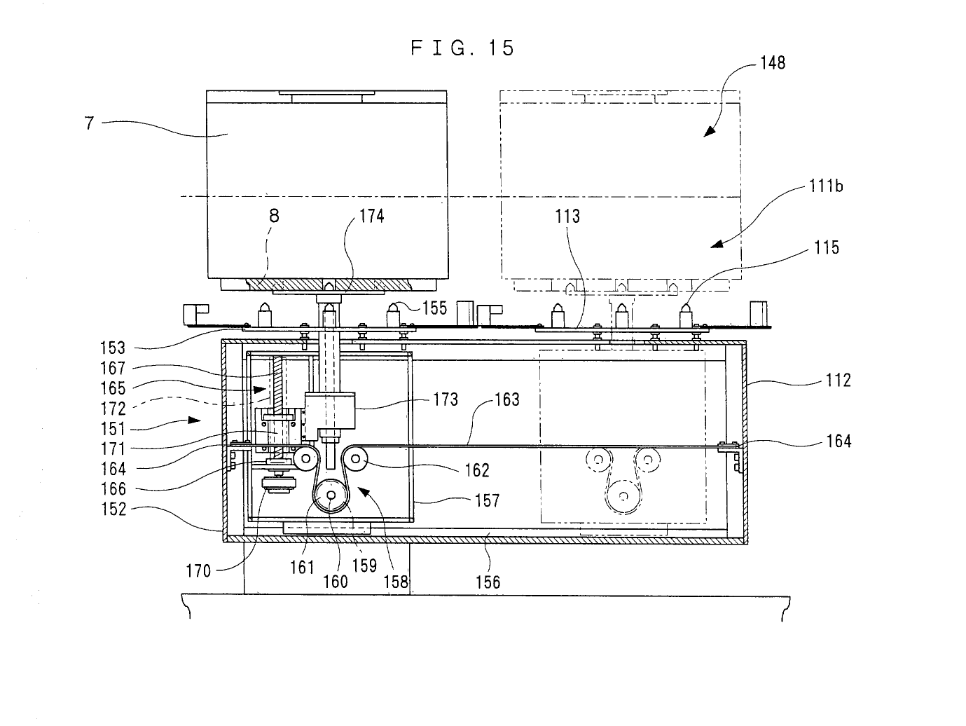

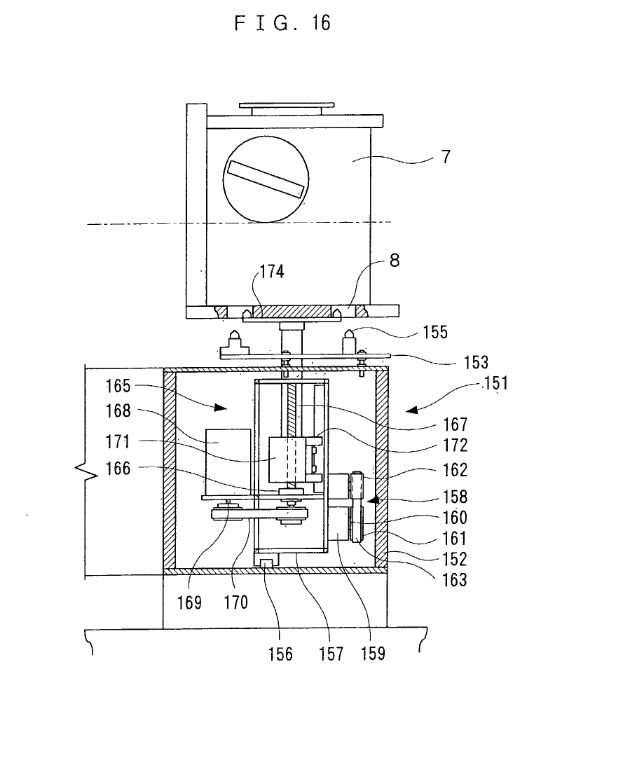

As described above, the cassette 7 taken out to the terminal end of the delivery means 111b can be stored by the storage means 151. Namely, the moving member 157 is moved to the side of the delivery means 111b, and the descending lifting/lowering body 174 is positioned below the lifting/lowering operating section 114 in the temporary receiving body 113. And then, after the lifting/lowering body 174 is moved up to lift the cassette 7 as indicated by virtual lines of FIG. 15, the moving member 157 is moved to the rotating end, so that the cassette 7 can be positioned above the temporary receiving body 153 as indicated by solid lines in FIG. 15 and FIG. 16.

Subsequently, the lifting/lowering body 174 is moved down via the lifting/lowering operating section 154 of the temporary receiving section 153, and the cassette 7 is thus placed on the side of the temporary receiving section 153 in a state in which the fitting sections 8 are fitted to the positioning pins 155. In this manner, the cassette 7 is positioned on the rotating end of the storage means 151 to be stored as indicated by K of FIG. 16.

In the above-described operations, the fitting sections 8 of the cassette 7 are fitted to the positioning pins 35, 82, 106, 115, 143, and 155, so that it is possible to prevent centrifugal force and so on during rotation from causing collision, displacement, or dropping of the cassettes 7.

As described above, the transfer means 51 only rotates the transfer operating section 81 around the transfer shaft 52 but does not have traveling movement and so on. Thus, it is not necessary to have an occupied space for traveling movement, so that the configuration including the rotary shelf 21 and the fixed shelves 101 can be entirely compact.

In addition, a storage amount can be increased by the rotary shelf 21 and the fixed shelves 101, and regarding the transfer means 51 having no traveling configuration, the transfer operating section 81 is moved down close to the floor, and the storing level of the load receiving section 32 of the rotary shelf 21 and the storing level of the load support section 103 of the fixed shelf 101 can be lowered close to the floor, thereby increasing the storage amount. Therefore, it is possible to suitably and readily adopt the transfer means 51 for a place where a clean space such as a clean room needs be minimized.

As described above, with positioning at the terminal end of the delivery means 111b, the cassette 7 taken out to a load take in/out section 148 and the cassette 7 stored in the storage means 151 can be supplied to the load handling device 180 by the load transfer means 191. Namely, as shown in FIGS. 1 to 4, the moving body 193 of the load transfer means 191 is moved on the transfer path 196 and is stopped above the terminal end of the desired delivery means 111b and the cassette 7 positioned at the storage means 151.

And then, after the load lifting device 195 is moved down to clamp the cassette 7, the load lifting device 195 is moved up to lift the cassette 7, and then, the lifted cassette 7 is held by the load holding section 194. In this state, the moving body 193 is moved on the transfer path 196 and is stopped above the carry-in device 185 in the load take in/out sections 184 of the desired load handling device 180.

And then, after the holding of the load holding section 194 is released, the load lifting device 195 is moved down to position the cassette 7 on the carry-in device 185. And then, after the clamping is released, the load lifting device 195 is moved up. Thus, the cassette 7 can be delivered to the load handling device 180 from the load storage device 10 by the load transfer means 191 provided in the clean room 5.

The cassette 7 positioned thus on the leading end of the carry-in device 185 can be carried into the surrounding wall body 181, that is, into the handling chamber 182 by the carry-in device 185. And then, after a load is taken out from the cassette 7 to perform predetermined handling, the handled load is stored again in the cassette 7. Subsequently, the cassette 7 is positioned at the leading end of the carry-out device 186 and is carried out to the outside the surrounding wall body 181, that is, the terminal end of the carry-out device 186 in the load take in/out section 184.

And then, the cassette 7 positioned on the terminal end of the carry-out device 186 is supported by the moving body 193 in the above-described manner and is carried on the transfer path 196. Thereafter, the cassette 7 is placed on the temporary receiving body 113 in the storing means 111a in the above-described manner, so that the cassette 7 can be carried into the load storage device 10, or the cassette 7 can be carried into another load handling device 180 to perform handling of a plurality of steps (a plurality of stages). Additionally, the connection path 203 is used to deliver the cassette 7 between the load handling systems 201.

Besides, in the clean room 5 and the connection clean room 202, since clean air A of down-flow type flows, dust appearing in the load take in/out sections 148 and 184, the load transfer means 191, and so on can be immediately removed along the flow. Therefore, in the clean room 5 and the connection clean room 202, cassette 7 can be carried in a sufficiently clean atmosphere (clean level).

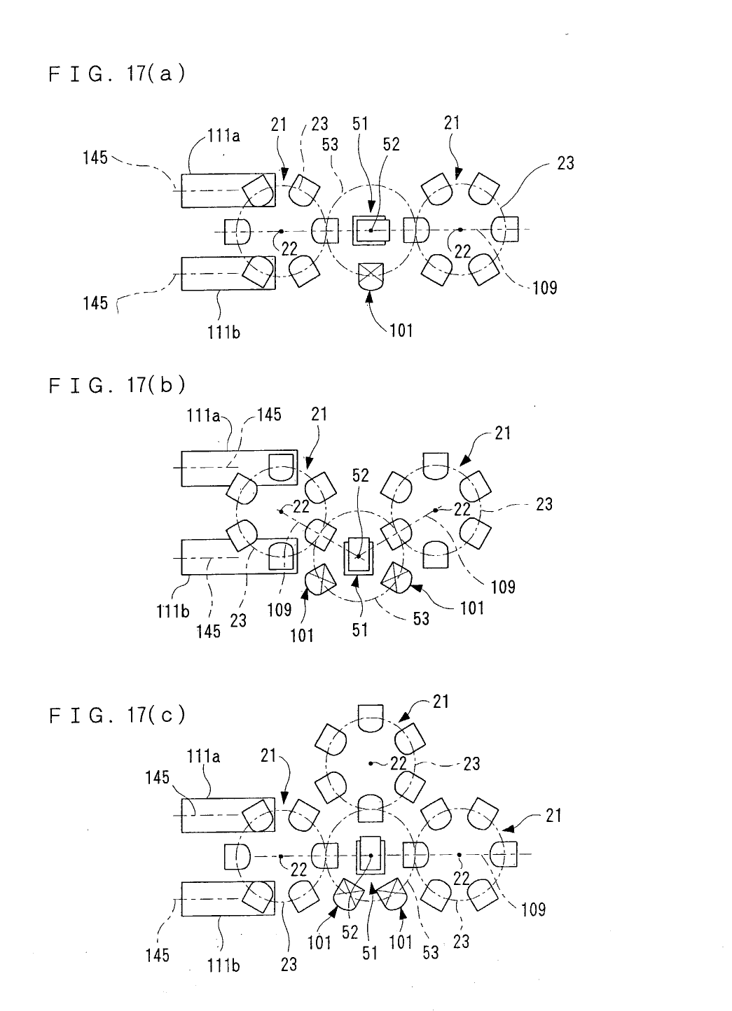

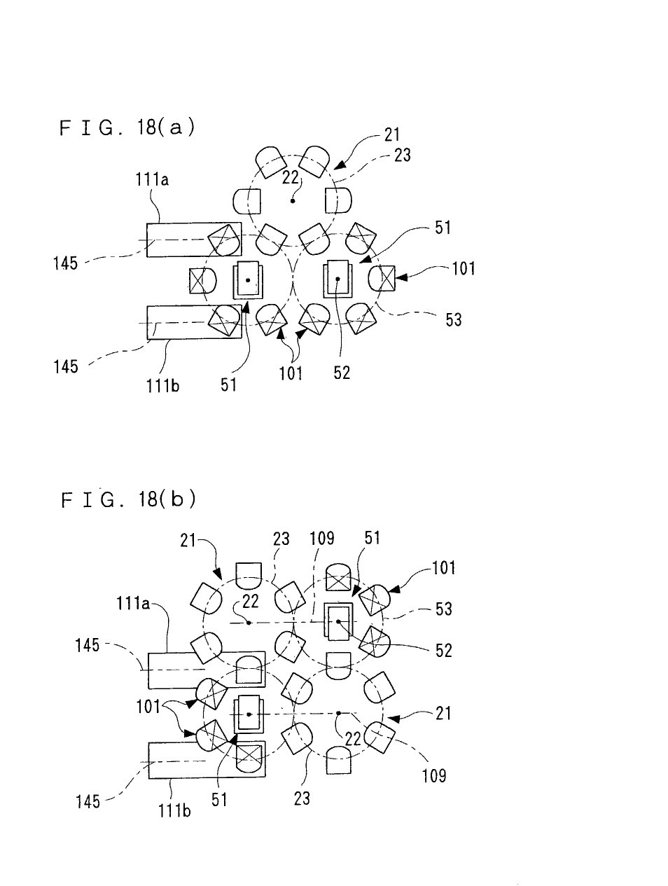

Referring to FIGS. 17 and 18, the following will discuss Examples 2 to 6 of the present invention that are variations of the load storage device 10.

FIG. 17(A) shows Example 2. Rotary shelves 21, transfer means 51, and fixed shelves 101 are provided while two (a plurality of) rotary circular paths 23 and one (a single) transfer circular path 53 are provided. Further, rotary shelf axes 22 of the rotary shelves 21 and a transfer shaft 52 of the transfer means 51 are positioned on the same line 109. Moreover, storing means 111a and delivery means 111b are positioned in a space formed on the lower part of the rotary shelf 21.

FIG. 17(B) shows Example 3, which is a variation of Example 2. A rotary shelf axis 22 of one of rotary shelves 21 is deviated from a line 109 connecting a rotary shelf axis 22 of the other rotary shelf 21 and a transfer shaft 52 of transfer means 51.

FIG. 17(C) shows Example 4. Rotary shelves 21, transfer means 51, and fixed shelves 101 are provided while three (a plurality of) rotary circular paths and one (a single) transfer circular path 53 are provided.

FIG. 18(A) shows Example 5. Rotary shelves 21, transfer means 51, and fixed shelves 101 are provided while one (a single) rotary circular path 23 and two (a plurality of) transfer circular paths 53 are provided.

FIG. 18(B) shows Example 6. Rotary shelves 21, transfer means 51, and fixed shelves 101 are provided while two rotary circular paths 23 and two transfer circular paths 53 are provided.

In the above-described Example 1, outer plates 13 and 14 of a load storage device 10 and an outer plate 183 of a load handling device 180 are also used as partition walls 187 to form a clean room 5. Thus, it is possible to reduce an amount of used materials of the partition walls 187, to achieve an inexpensive construction, and to allow the plates to reinforce each other. However, the clean room 5 may be formed only by the partition walls 187. In this case, the partition walls 187 are formed with openings for the load take in/out sections 148 and 184.

In the above-described Example 1, load transfer means 191 of an automatic traveling system is provided on the ceiling side in order to deliver the cassette 7 between the load storage device 10 and the load handling device 180. As load transfer means, it is possible to use a cart capable of automated traveling on a floor and a cart capable of traveling on a floor by being pushed with human hands. Further, the load transfer means may be eliminated to manually receive and deliver the cassette 7 in the clean room 5.

In the above-described examples, the transfer operating section 81 of the transfer means 51 is rotatably provided around the transfer shaft 52. The transfer means 51 may be provided without rotation.

In the above-described Example 1, as the transfer means 51, the turning body 70 is rotatably provided around the transfer shaft 52. The transfer means 51 including the transfer operating section 81 may be entirely provided to freely rotate around the transfer shaft positioned on, for example, a part of the post body 55.

In the above-described examples, the fixed shelves 101 are provided on the transfer circular path 53. The fixed shelves 101 may be eliminated.

In the above described Example 1, as the transfer means 51, the transfer operating section 81 is caused to operate on the bottom surface of the cassette 7. The transfer operating section 81 may be engaged from below to engaged parts protruding from the side and the top of the cassette 7.

In the above-described Example 1, the fixed shelves 101 are provided on a plurality of points on the transfer circular path 53. The fixed shelf 101 may be provided on a single point.

In the above-described examples, the rotary shelves 21 can rotate normally and reversely at 180° at the maximum. The normal and reverse rotation may be made at 180° or more, or the rotation may be made only in one direction.

In the above-described Example 1, the rotary shelves 21 are prepared firstly when the operation of the transfer means 51 is performed on the fixed shelves 101. The rotary shelves 21 may be prepared after completion of the operation of the transfer means 51 on the fixed shelves 101.

In the above-described Example 1, the cassette 7 is shown as a load. Other kinds of load are also applicable, and a palette may be handled.

In the above-described Example 1, the storing means 111a and the delivery means 111b are provided for the two fixed shelves 101, which are the farthest from the rotary shelves 21. The storing means 111a and the delivery means 111b may be provided for the two fixed shelves 101, one of which is the close to the rotary shelves 21 and the other is the farthest from the rotary shelves 21. In this case, two pairs of the storing means 111a and the delivery means 111b may be provided on both sides.

In the above-described Example 1, the configuration including the lifting/lowering unit 125 and the turning device 135 is shown as the storing means 111a and the delivery means 111b. The configuration using a roller conveyor and the configuration including a belt conveyor capable of moving up and down are also applicable.

In the above-described Example 1, the storage means 151 is provided in connection to the delivery means 111b. Alternatively, the storage means may be provided on the side of the storing means 111a, or the storage means 151 may be eliminated.

What is claimed is:

1. A load handling system having a load storage device and a load handling device, comprising:
load take in/out sections for the load storage device and the load handling device, each section facing a clean room defined by partition walls so that a load can be transferred between the load storage device and the load handling device in the clean room.

2. The load handling system according to claim 1, wherein the load storage device and the load handling device have the load take in/out sections formed on outer plates of the respective devices, and the outer plates are also used as partition walls.

3. The load handling system according to claim 1, further comprising load transfer means for receiving and delivering a load between the load storage device and the load handling device in the clean room.

4. The load handling system according to claim 1, wherein the load storage device has a rotary shelf, a fixed shelf, transfer means freely receiving and delivering a load between these shelves, and storing/retrieving means freely receiving and delivering a load by using the transfer means, the storing/retrieving means having an outer end positioned inside the clean room as a load take in/out section.

5. The load handling system according to claim 4, wherein the rotary shelf is freely rotatable around a rotary shelf axis in a vertical direction, a plurality of load receiving sections are provided on a rotary circular path having the rotary shelf axis as a center thereof, the transfer means is positioned laterally outside of the rotary shelf, a transfer operating section of the transfer means is freely rotatable around a transfer shaft in parallel with the rotary shelf axis, the transfer operating section is freely operable on a transfer circular path superimposed tangentially on the rotary circular path, the fixed shelf having load support sections is provided on the transfer circular path, the load receiving sections and the load support sections are provided on a plurality of vertically arranged stages, at least one of the rotary shelf and the fixed shelf has a space formed by eliminating the load receiving section and the load support section, and the storing/retrieving means is provided utilizing this space.

6. The load handling system according to any one of claims 1 to 5, wherein the load is a cassette capable of storing a handled load.
